(19) United States
(12) Patent Application Publication
(10) Pub. No.: US 2023/0397061 A1
(43) Pub. Date: Dec. 7, 2023

(54) METHOD AND APPARATUS FOR HANDOVER OF NON-TERRESTRIAL NETWORK CELL IN A WIRELESS COMMUNICATION SYSTEM

(71) Applicant: ASUS Technology Licensing Inc., Taipei City (TW)

(72) Inventors: Yi-Hsuan Huang, Taipei City (TW); Meng-Hui Ou, Taipei City (TW)

(21) Appl. No.: 18/205,280

(22) Filed: Jun. 2, 2023

Related U.S. Application Data
(60) Provisional application No. 63/348,378, filed on Jun. 2, 2022.

(51) Int. Cl. H04W 36/00; H04W 56/00; H04W 76/20; H04W 36/08

(52) U.S. Cl. CPC H04W 36/00835; H04W 56/0045; H04W 76/20; H04W 36/08; H04W 84/06

(57) ABSTRACT

Methods, systems, and apparatuses are provided for a UE comprising receiving a cell list from a system information of a first cell, wherein the cell list comprises at least a second cell and a second Non-Terrestrial Network (NTN) configuration for the second cell, receiving a Radio Resource Control (RRC) reconfiguration message indicating a target cell, wherein the RRC reconfiguration message does not comprise any NTN configuration for the target cell, and applying the second NTN configuration for the target cell based on the target cell is the second cell.

### CROSS-REFERENCE TO RELATED APPLICATIONS

The present application claims priority to and the benefit of U.S. Provisional Patent Application Ser. No. 63/348,378, filed Jun. 2, 2022, which is fully incorporated herein by reference.

### FIELD

This disclosure generally relates to wireless communication networks and, more particularly, to a method and apparatus for handover of Non-Terrestrial Network cell in a wireless communication system.

### BACKGROUND

With the rapid rise in demand for communication of large amounts of data to and from mobile communication devices, traditional mobile voice communication networks are evolving into networks that communicate with Internet Protocol (IP) data packets. Such IP data packet communication can provide users of mobile communication devices with voice over IP, multimedia, multicast and on-demand communication services.

An exemplary network structure is an Evolved Universal Terrestrial Radio Access Network (E-UTRAN). The E-UTRAN system can provide high data throughput in order to realize the above-noted voice over IP and multimedia services. A new radio technology for the next generation (e.g., 5G) is currently being discussed by the 3GPP standards organization. Accordingly, changes to the current body of 3GPP standard are currently being submitted and considered to evolve and finalize the 3GPP standard.

### SUMMARY

Methods, systems, and apparatuses are provided such that a User Equipment (UE) could know which Non-Terrestrial Network (NTN) assistance information (e.g., ntn-UlSyncValidityDuration, ta-Info, ephemerisInfo) to apply for a target cell, e.g., when the NTN assistance information is absent or omitted in a dedicated signal, in order to reduce signaling overhead for handover.

In various embodiments, a method of a UE comprises receiving a cell list from a system information of a first cell, wherein the cell list comprises at least a second cell and a second NTN configuration for the second cell, receiving a Radio Resource Control (RRC) reconfiguration message indicating a target cell, wherein the RRC reconfiguration message does not comprise any NTN configuration for the target cell, and applying the second NTN configuration for the target cell based on the target cell is the second cell.

In various embodiments, a method of a UE comprises receiving, from a system information of a first cell, at least a first NTN configuration for the first cell, receiving an RRC reconfiguration message indicating a target cell, wherein the RRC reconfiguration message does not comprise an NTN configuration for the target cell, and applying the first NTN configuration for the target cell.

### BRIEF DESCRIPTION OF THE DRAWINGS

FIG. 1 shows a diagram of a wireless communication system, in accordance with embodiments of the present invention.

FIG. 2 is a block diagram of a transmitter system (also known as access network) and a receiver system (also known as user equipment or UE), in accordance with embodiments of the present invention.

FIG. 3 is a functional block diagram of a communication system, in accordance with embodiments of the present invention.

FIG. 4 is a functional block diagram of the program code of FIG. 3, in accordance with embodiments of the present invention.

FIG. 5 is a reproduction of Figure. 5.3.5.1-1: RRC reconfiguration, successful, from R2-2206502, “Correction for NR NTN WI”.

FIG. 6 is a reproduction of Figure. 5.3.5.1-2: RRC reconfiguration, failure, from R2-2206502, “Correction for NR NTN WI”.

FIG. 7 is a flow diagram of a UE receiving a first information, using and/or applying the first information for a first cell and/or a second cell, receiving a handover command indicating a third cell, performing a handover procedure to link to the third cell, and using and/or applying the first information for the third cell, in accordance with embodiments of the present invention.

FIG. 8 is a flow diagram of a UE receiving a cell list from a system information of a first cell, wherein the cell list comprises at least a second cell and a second NTN configuration for the second cell, receiving an RRC reconfiguration message indicating a target cell, wherein the RRC reconfiguration message does not comprise any NTN configuration for the target cell, and applying the second NTN configuration for the target cell, in accordance with embodiments of the present invention.

FIG. 9 is a flow diagram of a UE receiving, from a system information of a first cell, at least a first NTN configuration for the first cell, receiving an RRC reconfiguration message indicating a target cell, wherein the RRC reconfiguration message does not comprise an NTN configuration for the target cell, and applying the first NTN configuration for the target cell, in accordance with embodiments of the present invention.

### DETAILED DESCRIPTION

The invention described herein can be applied to or implemented in exemplary wireless communication systems and devices described below. In addition, the invention is described mainly in the context of the 3GPP architecture reference model. However, it is understood that with the disclosed information, one skilled in the art could easily adapt for use and implement aspects of the invention in a 3GPP2 network architecture as well as in other network architectures.

The exemplary wireless communication systems and devices described below employ a wireless communication system, supporting a broadcast service. Wireless communication systems are widely deployed to provide various types of communication such as voice, data, and so on. These systems may be based on code division multiple access (CDMA), time division multiple access (TDMA), orthogonal frequency division multiple access (OFDMA), 3GPP LTE (Long Term Evolution) wireless access, 3GPP LTE-A (Long Term Evolution Advanced) wireless access, 3GPP2 UMB (Ultra Mobile Broadband), WiMax, 3GPP NR (New Radio), or some other modulation techniques.

In particular, the exemplary wireless communication systems and devices described below may be designed to support one or more standards such as the standard offered by a consortium named “3rd Generation Partnership Project” referred to herein as 3GPP, including: [1] RP-201256, “Solutions for NR to support non-terrestrial networks (NTN)”; [2] 3GPP TR 38.821 V16.0.0, “Solutions for NR to support non-terrestrial networks (NTN)”; [3] R2-2206502, “Correction for NR NTN WI”; [4] R2-2206503, “Corrections to Release-17 NR Non-Terrestrial Networks (NTN)”; and [5] 3GPP TS 38.331 V17.0.0, “NR, Radio Resource Control (RRC) protocol specification”. The standards and documents listed above are hereby expressly and fully incorporated herein by reference in their entirety.

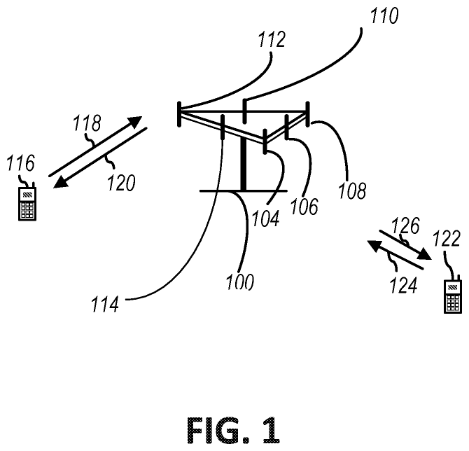

FIG. 1 shows a multiple access wireless communication system according to one embodiment of the invention. An access network 100 (AN) includes multiple antenna groups, one including 104 and 106, another including 108 and 110, and an additional including 112 and 114. In FIG. 1, only two antennas are shown for each antenna group, however, more or fewer antennas may be utilized for each antenna group. Access terminal (AT) 116 is in communication with antennas 112 and 114, where antennas 112 and 114 transmit information to access terminal 116 over forward link 120 and receive information from AT 116 over reverse link 118. AT 122 is in communication with antennas 106 and 108, where antennas 106 and 108 transmit information to AT 122 over forward link 126 and receive information from AT 122 over reverse link 124. In a FDD system, communication links 118, 120, 124 and 126 may use different frequency for communication. For example, forward link 120 may use a different frequency than that used by reverse link 118.

Each group of antennas and/or the area in which they are designed to communicate is often referred to as a sector of the access network. In the embodiment, antenna groups each are designed to communicate to access terminals in a sector of the areas covered by access network 100.

In communication over forward links 120 and 126, the transmitting antennas of access network 100 may utilize beamforming in order to improve the signal-to-noise ratio of forward links for the different access terminals 116 and 122. Also, an access network using beamforming to transmit to access terminals scattered randomly through its coverage normally causes less interference to access terminals in neighboring cells than an access network transmitting through a single antenna to all its access terminals.

The AN may be a fixed station or base station used for communicating with the terminals and may also be referred to as an access point, a Node B, a base station, an enhanced base station, an eNodeB, or some other terminology. The AT may also be called User Equipment (UE), a wireless communication device, terminal, access terminal or some other terminology.

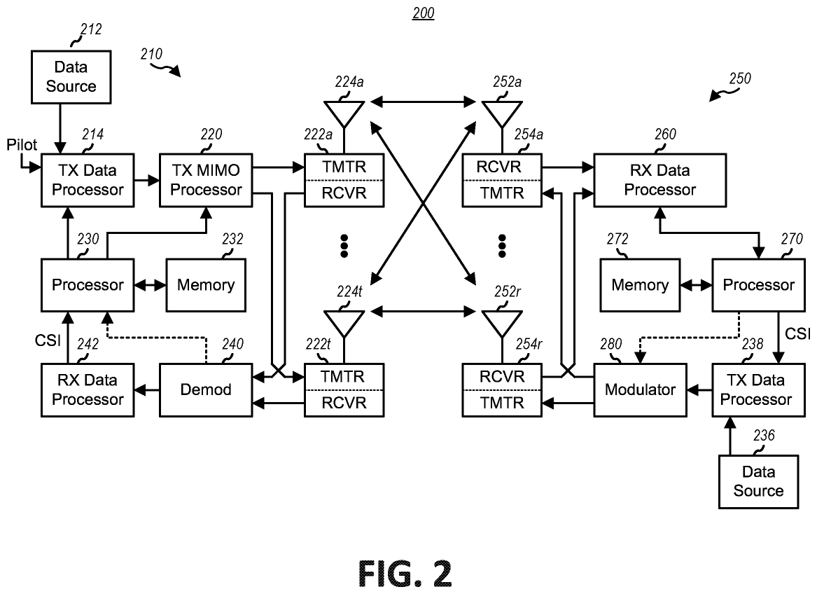

FIG. 2 is a simplified block diagram of an embodiment of a transmitter system 210 (also known as the access network) and a receiver system 250 (also known as access terminal (AT) or user equipment (UE)) in a MIMO system 200. At the transmitter system 210, traffic data for a number of data streams is provided from a data source 212 to a transmit (TX) data processor 214.

In one embodiment, each data stream is transmitted over a respective transmit antenna. TX data processor 214 formats, codes, and interleaves the traffic data for each data stream based on a particular coding scheme selected for that data stream to provide coded data.

The coded data for each data stream may be multiplexed with pilot data using OFDM techniques. The pilot data is typically a known data pattern that is processed in a known manner and may be used at the receiver system to estimate the channel response. The multiplexed pilot and coded data for each data stream is then modulated (e.g., symbol mapped) based on a particular modulation scheme (e.g., BPSK, QPSK, M-PSK, or M-QAM) selected for that data stream to provide modulation symbols. The data rate, coding, and modulation for each data stream may be determined by instructions performed by processor 230. A memory 232 is coupled to processor 230.

The modulation symbols for all data streams are then provided to a TX MIMO processor 220, which may further process the modulation symbols (e.g., for OFDM). TX MIMO processor 220 then provides N T modulation symbol streams to N T transmitters (TMTR) 222a through 222t. In certain embodiments, TX MIMO processor 220 applies beamforming weights to the symbols of the data streams and to the antenna from which the symbol is being transmitted.

Each transmitter 222 receives and processes a respective symbol stream to provide one or more analog signals, and further conditions (e.g., amplifies, filters, and upconverts) the analog signals to provide a modulated signal suitable for transmission over the MIMO channel. N T modulated signals from transmitters 222a through 222t are then transmitted from N T antennas 224a through 224t, respectively.

At receiver system 250, the transmitted modulated signals are received by N R antennas 252a through 252r and the received signal from each antenna 252 is provided to a respective receiver (RCVR) 254a through 254r. Each receiver 254 conditions (e.g., filters, amplifies, and downconverts) a respective received signal, digitizes the conditioned signal to provide samples, and further processes the samples to provide a corresponding “received” symbol stream.

An RX data processor 260 then receives and processes the N R received symbol streams from N R receivers 254 based on a particular receiver processing technique to provide N T “detected” symbol streams. The RX data processor 260 then demodulates, deinterleaves, and decodes each detected symbol stream to recover the traffic data for the data stream. The processing by RX data processor 260 is complementary to that performed by TX MIMO processor 220 and TX data processor 214 at transmitter system 210.

A processor 270 periodically determines which pre-coding matrix to use (discussed below). Processor 270 formulates a reverse link message comprising a matrix index portion and a rank value portion.

The reverse link message may comprise various types of information regarding the communication link and/or the received data stream. The reverse link message is then processed by a TX data processor 238, which also receives traffic data for a number of data streams from a data source 236, modulated by a modulator 280, conditioned by transmitters 254a through 254r, and transmitted back to transmitter system 210.

At transmitter system 210, the modulated signals from receiver system 250 are received by antennas 224, conditioned by receivers 222, demodulated by a demodulator 240, and processed by a RX data processor 242 to extract the reserve link message transmitted by the receiver system 250. Processor 230 then determines which pre-coding matrix to use for determining the beamforming weights then processes the extracted message.

Memory 232 may be used to temporarily store some buffered/computational data from 240 or 242 through Processor 230, store some buffed data from 212, or store some specific program codes. And Memory 272 may be used to temporarily store some buffered/computational data from 260 through Processor 270, store some buffed data from 236, or store some specific program codes.

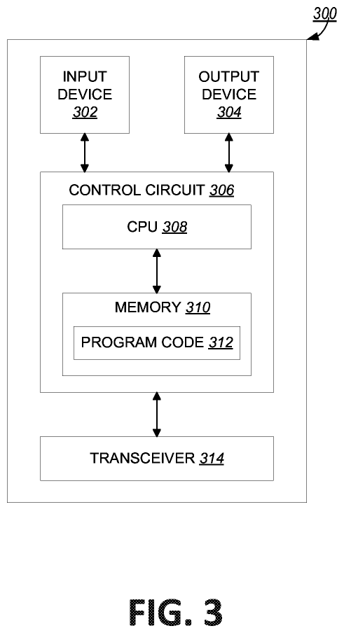

Turning to FIG. 3, this figure shows an alternative simplified functional block diagram of a communication device according to one embodiment of the invention. As shown in FIG. 3, the communication device 300 in a wireless communication system can be utilized for realizing the UEs (or ATs) 116 and 122 in FIG. 1, and the wireless communications system is preferably the NR system. The communication device 300 may include an input device 302, an output device 304, a control circuit 306, a central processing unit (CPU) 308, a memory 310, a program code 312, and a transceiver 314. The control circuit 306 executes the program code 312 in the memory 310 through the CPU 308, thereby controlling an operation of the communications device 300. The communications device 300 can receive signals input by a user through the input device 302, such as a keyboard or keypad, and can output images and sounds through the output device 304, such as a monitor or speakers. The transceiver 314 is used to receive and transmit wireless signals, delivering received signals to the control circuit 306, and outputting signals generated by the control circuit 306 wirelessly.

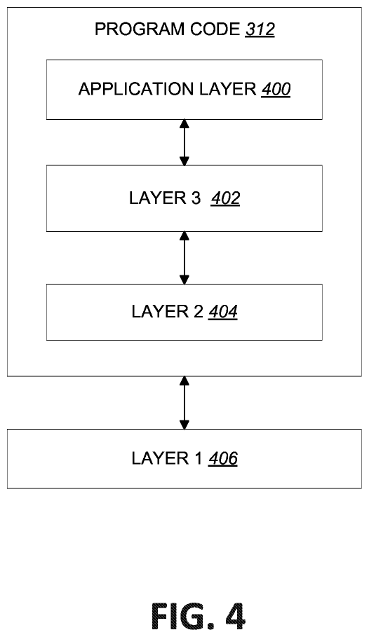

FIG. 4 is a simplified block diagram of the program code 312 shown in FIG. 3 in accordance with an embodiment of the invention. In this embodiment, the program code 312 includes an application layer 400, a Layer 3 portion 402, and a Layer 2 portion 404, and is coupled to a Layer 1 portion 406. The Layer 3 portion 402 generally performs radio resource control. The Layer 2 portion 404 generally performs link control. The Layer 1 portion 406 generally performs physical connections.

For LTE, LTE-A, or NR systems, the Layer 2 portion 404 may include a Radio Link Control (RLC) layer and a Medium Access Control (MAC) layer. The Layer 3 portion 402 may include a Radio Resource Control (RRC) layer.

Any two or more than two of the following paragraphs, (sub-)bullets, points, actions, or claims described in each invention paragraph or section may be combined logically, reasonably, and properly to form a specific method.

Any sentence, paragraph, (sub-)bullet, point, action, or claim described in each of the following invention paragraphs or sections may be implemented independently and separately to form a specific method or apparatus. Dependency, e.g., “based on”, “more specifically”, “example”, etc., in the following invention disclosure is just one possible embodiment which would not restrict the specific method or apparatus.

The description of the Rel-17 work item of Non-terrestrial Networks (NTN) in New Radio (NR) is specified in [1] RP-201256, “Solutions for NR to support non-terrestrial networks (NTN)”:

### ************************************** Quotation Start [1] **********************************

### 3 Justification

Non-terrestrial networks refer to networks, or segments of networks, using an airborne or spaceborne vehicle for transmission:
Spaceborne vehicles: Satellites (including Low Earth Orbiting (LEO) satellites, Medium Earth Orbiting (MEO) satellites, Geostationary Earth Orbiting (GEO) satellites as well as Highly Elliptical Orbiting (HEO) satellites)
Airborne vehicles: High Altitude Platforms (HAPs) encompassing Unmanned Aircraft Systems (UAS) including Lighter than Air UAS (LTA), Heavier than Air UAS (HTA), all operating in altitudes typically between 8 and 50 km, quasi-stationary.

In 3GPP TS 22.261 approved at SA #82, use cases for 5G Satellite integration and the corresponding service requirements have been identified as result of the work item “5GSAT”. This will address mobile broadband needs in unserved/underserved areas as well as public safety needs, maritime (3GPP TS 22.119 “Maritime communication services over 3GPP system”), airplane connectivity and railway communication service requirements applicable to satellite access.

Since RAN #76, two activities on NR to support Non-Terrestrial Networks have been successively carried out
A first activity, FS_NR_nonterr_nw (see RP-171450) studied the channel model for the non-terrestrial networks, to define deployment scenarios, parameters and identify the key potential impacts on NR. The work led by RAN started at RAN #76 and has been completed at RAN #80. The results are reflected in TR 38.811.
A second activity, FS_NR_NTN_solutions (see RP-190710), define and evaluate solutions for the identified key impacts from the first activity. The work led by RAN3 started at RAN #80 and is planned to be completed at RAN #86. The results are reflected in TR 38.821 (RP-193062).

Furthermore an email discussion took place between RAN #85 and #86 on the scoping of a REl-17 WI on non-terrestrial network. The report of this email discussion is available in RP-192500. It concluded that the Rel-17 NR-NTN NWI should include two activities:
Normative activity on NR-NTN to develop specifications to support the following scenarios:
   Transparent payload based LEO scenario addressing at least 3GPP class 3 UE with and without GNSS capability and both Earth fixed &/or moving cell scenario (as per SI outcome).
      Note 1: Addressing LEO will provide the flexibility to also support transparent payload based HAPS based scenarios.
   Transparent payload based GEO scenario addressing UE with GNSS capability.
      Note 2: Addressing LEO and GEO scenarios will enable NR to support all NGSO scenarios with circular orbit at altitude greater than or equal to 600 km.
Study activity on NTN scenarios addressing
   Transparent payload based HAPS scenarios: Study of enablers for Spectrum coexistence with cellular (additional Coresets, PCI confusion mitigation, . . . )
   IoT-NTN based scenarios
   NTN-network based location of UE (for regulatory services): identify possible solutions

Based on the above points, a new work item is proposed to carry the conclusion of the FS_NR_NTN_solutions study item and specify the solutions enabling NR to support non-terrestrial networks.

Addressing LEO and GEO scenarios will enable to support all NGSO scenarios with circular orbit at altitude greater than or equal to 600 km.

### 4 Objective

### 4.1 Objective of SI or Core Part WI or Testing Part WI

The work item aims to specify the enhancements identified for NR NTN (non-terrestrial networks) especially LEO and GEO with implicit compatibility to support HAPS (high altitude platform station) and ATG (air to ground) scenarios according to the following principles:
FDD is assumed for core specification work for NR-NTN.
   NOTE: This does not imply that TDD cannot be used for relevant scenarios e.g. HAPS, ATG
Earth fixed Tracking area is assumed with Earth fixed and moving cells
UEs with GNSS capabilities are assumed.
Transparent payload is assumed
   [ . . . ]

The following control plane procedures enhancements should be specified (see TR 38.821)
Idle mode:
   Definition of additional assistance information for cell selection/reselection (e.g. using UE location information, satellite Ephemeris information)
   Definition of NTN (satellite/HAPS) cell specific information in SIB
Connected mode
   Enhancement necessary to take into account location information (UE & Satellite/HAPS) and/or ephemeris in determining when to perform hand-over, in order to have a high degree of hand-over control for hand-over robustness and coverage management.
Enhancement to existing measurement configurations to address absolute propagation delay difference between satellites (e.g. SMTC measurement gap adaptation to the SSB/CSI-RS measurement window) [RAN2/4].
Service continuity for mobility from TN to NTN and from NTN to TN systems (to be addressed when connected mode mobility has sufficiently progressed)
Identify potential issues associated to the use of the existing Location Services (LCS) application protocols to locate UE in the context of NTN and specify adaptations if any [RAN2/3]

### ************************************** Quotation End **************************************

The current endorsed NR RRC CR for NTN is specified in R2-2206502 ([3] R2-2206502, “Correction for NR NTN WI”) as provided below:

### ************************************** Quotation Start [3] **********************************

### 5.2.5.4.2.1 Actions Upon Reception of SIB19

Upon receiving SIB19, the UE shall:
1> start or restart Txxx with the duration ntn-UlSyncValidityDuration from the subframe indicated by epochTime;
NOTE: UE should attempt to re-acquire SIB19 before the end of the duration indicated by ntn-UlSyncValidityDuration and epochTime by UE implementation.

### ************************************** Next Quotation **************************************

### 5.2.2.X Txxx Expiry

The UE shall:
1> if in RRC_CONNECTED:
   2> inform lower layers that UL synchronisation is lost;
   2> acquire SIB19 as defined in clause 5.2.2.3.2;
   2> upon successful acquisition of SIB19:
      3> inform lower layers that UL synchronisation is obtained;

### ************************************** Next Quotation **************************************

### 5.3.5 RRC Reconfiguration

### 5.3.5.1 General

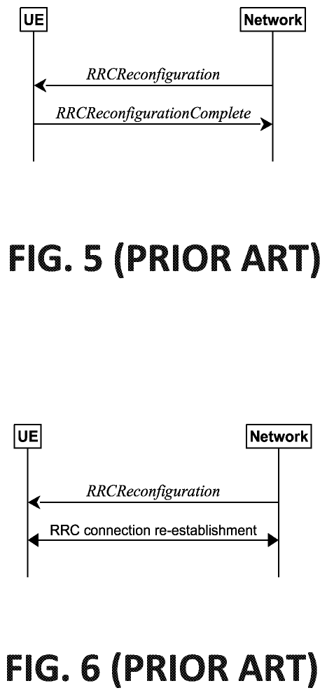

FIG. 5 is a reproduction of Figure. 5.3.5.1-1: RRC reconfiguration, successful, from R2-2206502, “Correction for NR NTN WI”.

FIG. 6 is a reproduction of Figure. 5.3.5.1-2: RRC reconfiguration, failure, from R2-2206502, “Correction for NR NTN WI”.

The purpose of this procedure is to modify an RRC connection, e.g. to establish/modify/release RBs/BH RLC channels, to perform reconfiguration with sync, to setup/modify/release measurements, to add/modify/release SCells and cell groups, to add/modify/release conditional handover configuration, to add/modify/release conditional PSCell change or conditional PSCell addition configuration. As part of the procedure, NAS dedicated information may be transferred from the Network to the UE.

[ . . . ]

### 5.3.5.2 Initiation

The Network may initiate the RRC reconfiguration procedure to a UE in RRC_CONNECTED. The Network applies the procedure as follows:

[ . . . ]
the reconfigurationWithSync is included in masterCellGroup only when AS security has been activated, and SRB2 with at least one DRB or multicast MRB or, for IAB, SRB2, are setup and not suspended;
   [ . . . ]
   5.3.5.8.3. T304 Expiry (Reconfiguration with Sync Failure) or T420 Expiry (Path Switch Failure)

The UE shall:
1> if T304 of the MCG expires, or
1> if T420 expires, or,
1> if the target L2 U2N Relay UE changes its serving PCell before path switch (i.e. the received RRCReconfiguration message containing reconfigurationWithSync indicating path switch as specified in 5.3.5.5.2):
   2> release dedicated preambles provided in rach-ConfigDedicated if configured;
   2> release dedicated msgA PUSCH resources provided in rach-ConfigDedicated if configured;
   2> if any DAPS bearer is configured, and radio link failure is not detected in the source PCell, according to clause
      3> reset MAC for the target PCell and release the MAC configuration for the target PCell;
      3> for each DAPS bearer:
         4> release the RLC entity or entities as specified in TS 38.322 [4], clause 5.1.3, and the associated logical channel for the target PCell;
         4> reconfigure the PDCP entity to release DAPS as specified in TS 38.323 [5];
      3> for each SRB:
         4> if the masterKeyUpdate was not received:
         5> configure the PDCP entity for the source PCell with state variables continuation as specified in TS 38.323 [5];
         4> release the PDCP entity for the target PCell;
         4> release the RLC entity as specified in TS 38.322 [4], clause 5.1.3, and the associated logical channel for the target PCell;
         4> trigger the PDCP entity for the source PCell to perform SDU discard as specified in TS 38.323 [5];
         4> re-establish the RLC entity for the source PCell;
         3> release the physical channel configuration for the target PCell;
      3> discard the keys used in target PCell (the K_{gNB} key, the K_{RRCene} key, the K_{RRCint} key, the K_{UPint} key and the K_{UPenc} key), if any;
      3> resume suspended SRBs in the source PCell;
      3> for each non-DAPS bearer:
         4> revert back to the UE configuration used for the DRB or multicast MRB in the source PCell, includes PDCP, RLC states variables, the security configuration and the data stored in transmission and reception buffers in PDCP and RLC entities;
         3> revert back to the UE measurement configuration used in the source PCell;
      3> store the handover failure information in VarRLF-Report as described in the clause 5.3.10.5;
      3> initiate the failure information procedure as specified in clause 5.7.5 to report DAPS handover failure.
   2> else:
      3> revert back to the UE configuration used in the source PCell;
      3> if the associated T304 was not initiated upon cell selection performed while timer T311 was running, as defined in clause 5.3.7.3:
         4> store the handover failure information in VarRLF-Report as described in the clause 5.3.10.5;
      3> initiate the connection re-establishment procedure as specified in clause 5.3.7.
   NOTE 1: In the context above, “the UE configuration” includes state variables and parameters of each radio bearer.
   [ . . . ]
      3> if the UE is in NR-DC:
         4> initiate the connection re-establishment procedure as specified in clause 5.3.7;
      3> else (the UE is in (NG) EN-DC):
         4> initiate the connection re-establishment procedure as specified in TS 36.331 [10], clause 5.3.7;
1> else if T304 expires when RRCReconfiguration is received via other RAT (HO to NR failure):
   2> reset MAC;
   2> perform the actions defined for this failure case as defined in the specifications applicable for the other RAT.
NOTE 2: In this clause, the term ‘handover failure’ has been used to refer to ‘reconfiguration with sync failure’.

### ************************************** Next Quotation **************************************

RRCReconfiguration

The RRCReconfiguration message is the command to modify an RRC connection. It may convey information for measurement configuration, mobility control, radio resource configuration (including RBs, MAC main configuration and physical channel configuration) and AS security configuration.

Signalling radio bearer: SRB1 or SRB3
RLC-SAP: AM
Logical channel: DCCH
Direction: Network to UE

RRCReconfiguration message

| | |
|---|---|
| RRCReconfiguration ::= | SEQUENCE { |
| rrc-TransactionIdentifier | RRC-TransactionIdentifier, |
| criticalExtentions | CHOICE { |
| rrcReconfiguration | RRCReconfiguration-IEs, |
| criticalExtentionFuture | SEQUENCE { } |
| } | |
| } | |
| RRCReconfiguration-IEs ::= | SEQUENCE { |
| [...] | |
| nonCriticalExtension | RRCReconfiguration-v1530-IEs |
| OPTIONAL | |
| } | |
| RRCReconfiguration-v1530-IEs ::= | SEQUENCE { |
| masterCellGroup | OCTET STRING (CONTAINING CellGroupConfig) |
| OPTIONAL, -- Need M | |
| fullConfig | ENUMERATED {true} |
| OPTIONAL, -- Cond FullConfig | |
| dedicatedNAS-MessageList | SEQUENCE (SIZE(1..maxDRB)) OF DedicatedNAS-Message |
| OPTIONAL, -- Cond nonHO | |
| masterKeyUpdate | MasterKeyUpdate |
| OPTIONAL, -- Cond MasterKeyChange | |
| dedicatedSIB1-Delivery | OCTET STRING (CONTAINING SIB1) |
| OPTIONAL, -- Need N | |
| dedicatedSystemInformationDelivery | OCTET STRING (CONTATINING SystemInformation) |
| OPTIONAL, -- Need N | |
| otherConfig | OtherConfig |
| OPTIONAL, -- Need M | |
| nonCriticalExtension | RRCReconfiguration-v1540-IEs |
| OPTIONAL | |
| } | |
| [...] | |

RRCReconfiguration-IEs field descriptions
conditionalReconfiguration
Configuration of candidate target SpCell(s) and execution condition(s) for conditional handover, conditional PSCell
addition or conditional PSCell change. The field is absent if any DAPS bearer is configured or if the masterCellGroup
includes ReconfigurationWithSync. For conditional PSCell change, the field is absent if the secondaryCellGroup includes
ReconfigurationWithSync. The RRCReconfiguration message contained in DLInformation TransferMRDC cannot contain
the field conditionalReconfiguration for conditional PSCell change and conditional PSCell addition.
dedicatedSystemInformationDelivery
This field is used to transfer SIB6, SIB7, SIB8, SIB19 to the UE with an active BWP with no common serach space
configured. For UEs in RRC_CONNECTED, this field is used to transfer the SIBs requested on-demand.
fullConfig
Indicates that the full configuration option is applicable for the RRCReconfiguration message for intra-system intra-RAT
HO. For inter-RAT HO from E-UTRA to NR, fullConfig indicates whether or not delta signalling of SDAP/PDCP from
source RAT is applicable. This field is absent if any DAPS bearer is configured or when the RRCReconfiguration
message is transmitted on SRB3, and in an RRCReconfiguration message for SCG contained in another
RRCReconfiguration message (or RRCConnectionReconfiguration message, see TS 36.331 [10]) transmitted on SRB1.
[... ]

RRCReconfigurationComplete

The RRCReconfigurationComplete message is used to confirm the successful completion of an RRC connection reconfiguration.
Signalling radio bearer: SRB1 or SRB3
RLC-SAP: AM
Logical channel: DCCH
Direction: UE to Network

### ************************************** Next Quotation **************************************

SIB19

SIB19 contains satellite assistance information.

SIB19 information element

| SIB19-r17 ::= SEQUENCE { | | |
|---|---|---|
| ntn-Config-r17 | NTN-config-r17 | OPTIONAL, |
| -- Need R | | |
| t-Service-r17 | INTEGER (0..549755813887) | OPTIONAL, |
| -- Need R | | |
| referenceLocation-r17 | ReferenceLocation-r17 | OPTIONAL, |
| -- Need R | | |
| distanceThresh-r17 | INTEGER(0..65525) | OPTIONAL, |
| -- Need R | | |
| ntn-NeighCellConfigList-r17 | NTN-NeighCellConfigList-r17 | OPTIONAL, |
| -- Need R | | |
| lateNonCriticalExtension | OCTET STRING | OPTIONAL, |
| ... | | |
| } | | |
| NTN-NeighCellConfigList-r17 ::= | SEQUENCE (SIZE(1..maxCellNTN)) OF NTN-NeighCellConfig-r17 | |
| NTN-NeighCellConfig-r17 ::= | SEQUENCE { | |
| ntn-config-r17 | NTN-Config-r17 | OPTIONAL, |
| -- Need R | | |
| carrierFreq-r17 | ARFCN-ValueNR | OPTIONAL, |
| -- Need R | | |
| physCellId-r17 | PhysCellId | OPTIONAL |
| --Need R | | |
| } | | |

SIB19 field descriptions
distanceThresh
Distance from the serving cell reference location and is used in location-based measurement initiation in RRC_IDLE and
RRC_INACTIVE, as defined in TS 38.304 [20]. Each step represents 50 m.
ntn-Config
Provides parameters needed for the UE to access NR via NTN access such as Ephemeris data, common TA
parameters, k_offset, validity duration for UL sync information and epoch time. The valididy duration, ntn-
UISyncValidityDuration, is mandatory present.
ntn-NeighCellConfigList
Provides a list of NTN neighbour cells including their ntn-Config, carrier frequency and PhysCellId.
referenceLocation
Reference location of the serving cell provided via NTN quasi-Earth fixed system and is used in location-based
measurement initiation in RRC_IDLE and RRC_INACTIVE, as defined in TS 38.304 [20].
t-Service
Indicates the time information on when a cell provided via NTN quasi-Earth fixed system is going ot stop serving the area
it is currently covering. The field indicates a time in multiples of 10 ms after 00:00:00 on Gregorian calendar date
1 Jan. 1900 (midnight between Sunday, Dec. 31, 1899 and Monday, Jan. 1, 1900). This field is excluded
when determining changes in system information, i.e. changes of t-Service should neither result in system information
change notifications nor in a modification of valueTag in SIB1. The exact stop time is between the time indicated by the
value of this field minus 1 and the time indicated by the value of this field.

### ************************************** Next Quotation **************************************

EphemerisInfo

The IE EphemerisInfo provides satellite ephemeris. Ephemeris may be expressed either in format of position and velocity state vector or in format of orbital parameters. FFS more detailed description.

EphemerisInfo information element

| | |
|---|---|
| EphemerisInfo-r17 ::= | CHOICE { |
| positionVelocity-417 | PositionVelocity-r17, |
| orbital-r17 | Orbital-r17 |
| } | |
| PositionVelocity-r17 ::= | SEQUENCE { |
| positionX-r17 | PositionStateVecotr-r17, |
| positionY-r17 | PositionStateVecotr-r17, |
| positionZ-r17 | PositionStateVecotr-r17, |
| velocityVX-r17 | VelocityStateVector-r17, |
| velocityVY-r17 | VelocityStateVector-r17, |
| velocityVZ-r17 | VelocityStateVector-r17, |
| } | |
| Orbital-r17 ::= | SEQUENCE { |
| semiMajorAxis-r17 | INTEGER (0..8589934591), |
| eccentricity-r17 | INTEGER (0..1048575), |
| periapsis-r17 | INTEGER (0..268435455), |
| longitude-r17 | INTEGER (0..268435455), |
| inclination-r17 | INTEGER (−67108864..67108863), |
| meanAnomaly-r17 | INTEGER (0..268435455) |
| } | |

PositionState Vector-r17 ::= INTEGER (−33554432..33554431)
VelocityStateVector-r17 ::= INTEGER (−131072..131071)
EphemerisInfo field descriptions
anomaly
Satellite orbital parameter: Mean anomaly M at epoch time, see
NIMA TR 8350.2 [X]. Unit is radian.
Step of 2.341* 10⁻⁸ rad. Actual value = field value * (2.341* 10⁻⁸).
eccentricity
Satellite orbital parameter: eccentricity e, see NIMA TR 8350.2 [X].
Step 1.431 * 10⁻⁸. Actual value = field value * (1.431 * 10⁻⁸).
inclination
Satellite orbital parameter: inclination i, see NIMA TR 8350.2 [X].
Unit is radian.
Step of 2.341* 10⁻⁸ rad. Actual value = field value * (2.341* 10⁻⁸).
longitude
Satellite orbital parameter: longitude of ascending node Ω, see
NIMA TR 8350.2 [X]. Unit is radian.
Step of 2.341* 10⁻⁸ rad. Actual value = field value * (2.341* 10⁻⁸).
periapsis
Satellite orbital paramater: argument of periapsis ω, see NIMA TR
8350.2 [X]. Unit is radian.
Step of 2.341* 10⁻⁸ rad. Actual value = field value (2.341* 10⁻⁸).
posistionX, positionY, positionZ
X, Y, Z coordinate of satellite position state vector in ECEF.
Unit is meter.
Step of 1.3 m. Actual value = field value * 1.3.
semiMajorAxis
Satellite orbital parameter: semi major axis α, see NIMA TR
8350.2 [X]. Unit is meter.
Step of 4.249 * 10⁻³ m. Actual value = 6500000 + field value *
(4.249 * 10⁻³).
velocityVX, velocityVY, velocityVZ
X, Y, Z coordinate of satellite velocity state vector in ECEF. Unit is
meter/second.
Step of 0.06 m/s. Actual value = field value * 0.06.

### ************************************** Next Quotation **************************************

CellGroupConfig

The CellGroupConfig IE is used to configure a master cell group (MCG) or secondary cell group (SCG). A cell group comprises of one MAC entity, a set of logical channels with associated RLC entities and of a primary cell (SpCell) and one or more secondary cells (SCells).

CellGroupConfig information element

| | |
|---|---|
| CellGroupConfig ::= | SEQUENCE { |
| cellGroupId | CellGroupId, |
| [...] | |
| mac-CellGroupConfig | MAC-CellGroupConfig |
| OPTIONAL, -- Need M | |
| physicalCellGroupConfig | PhysicalCellGroupConfig |
| OPTIONAL, -- Need M | |
| spCellConfig | SpCellConfig |
| OPTIONAL, -- Need M | |
| [...] | |
| } | |
| SpCellConfig ::= | SEQUENCE { |
| servCellIndex | ServCellIndex |
| OPTIONAL, -- cond SCG | |
| reconfigurationWithSync | ReconfigurationWithSync |
| OPTIONAL, -- Cond ReconfWithSync | |
| [...] | |
| } | |
| ReconfigurationWithSync ::= | SEQUENCE { |
| spCellConfigCommon | ServingCellConfigCommon |
| OPTIONAL, -- Need M | |
| newUE-Identity | RNTI-Value, |
| t304 | ENUMERATED {ms50, ms100, ms150, ms200, |
| ms500, ms1000, ms2000, ms10000}, | |
| rach-ConfigDedicated | CHOICE { |
| uplink | RACH-ConfigDedicated, |
| supplementaryUplink | RACH-ConfigDedicated |
| } | |
| OPTIONAL, -- Need N | |
| ..., | |
| smtc | SSB-MTC |
| OPTIONAL -- Need S | |
| [...] | |
| } | |
| [...] | |

CellGroupConfig field descriptions
spCellConfig
parameters for the SpCell of this cell group (PCell of MCG or PSCell of SCG).
SpCellConfig field descripitons
reconfigurationWithSync
Parameters for the synchronous reconfiguration to the target SpCell.
rlf-TimersAndConstants
Timers and constants for detecting and triggering cell-level radio link failure. For the SCG,
rlf-TimersAndConstants can only be set to setup and is always included at SCG addition.
servCellIndex
Serving cell ID of a PSCell. The PCell of the Master Cell Group uses ID = 0.

| Conditional Presence | Explanation | | |
|---|---|---|---|
| ReconfWithSync | The field is mandatory present in the RRCReconfiguration message: | | |
| | - | in each configured CellGroupConfig for which the SpCell changes, | |
| | - | in the masterCellGroup: | |
| | | - | at change of AS security key derived from K_{gNB}, |
| | | - | in an RRCReconfiguration message contained in a |
| | | | DLInformationTransferMRDC message. |
| | | - | path switch to the target PCell for a L2 U2N Remote UE, |
| | | - | path switch to the target L2 U2N Relay UE, |
| | - | In the secondaryCellGroup at: | |
| | | - | PSCell addition, |
| | | - | SCG resume with NR-DC or (NGEN-DC, |
| | | - | update of required SI for PSCell, |
| | | - | change of AS security key derived from S-K_{gNB} in NR-DC |
| | | | while the UE is configured with at least one radio bearer with |
| | | | keyToUse set to secondary and that is not released by this |
| | | | RRCReconfiguration message, |
| | | - | MN handover in (NG)EN-DC. |

Otherwise, it is optionally present, need M. The field is absent in the
masterCellGroup in RRCResume and RRCSetup messages and is absent
in the masterCellGroup in RRCReconfiguration message if source
configuration is not released during DAPS handover.

### ************************************** Next Quotation **************************************

NTN-Config

The IE NTN-Config provides parameters needed for the UE to access NR via NTN access.

NTN-Config information element

| | |
|---|---|
| NTN-Config-r17 ::= | SEQUENCE { |

| | |
|---|---|
| epochTime-r17 | EpochTime-r17 |
| OPTIONAL, -- Need R | |
| ntn-UlSyncValidityDuration-r17 | ENUMERATED{ s5, s10, s15, s20, s25, s30, s35, |
| | s40, s45, s50, s55, s60, s120, s180, s240, s900} |
| OPTIONAL, -- Need R | |
| cellSpecificKoffset-r17 | INTEGER(1..1023) |
| OPTIONAL, -- Need R | |
| kmac-r17 | INTEGER(1..512) |
| OPTIONAL, -- Need R | |
| ta-Info-r17 | TA-Info-r17 |
| OPTIONAL, -- Need R | |
| ntn-PolarizationDL-r17 | ENUMERATED {rhcp, lhcp, linear} |
| OPTIONAL, -- Need R | |
| ntn-PolarizationUL-r17 | ENUMERATED {rhcp, lhcp, linear} |
| OPTIONAL, -- Need R | |
| ephemerisInfo-r17 | EphemerisInfo-r17 |
| OPTIONAL, -- Need R | |
| ta-Report-r17 | ENUMERATED {enabled} |
| OPTIONAL, -- Need R | |
| } | |

| | |
|---|---|
| EpochTime-r17 ::= | SEQUENCE { |

| | |
|---|---|
| sfn-r17 | INTEGER(0..1023), |
| subFrameNR-r17 | INTEGER(0..9) |
| } | |

| | |
|---|---|
| TA-Info-r17 ::= | SEQUENCE { |

| | |
|---|---|
| ta-Common-r17 | INTEGER(0..66485757), |
| ta-CommonDrift-r17 | INTEER(−257303.. 257303) |
| OPTIONAL, -- Need R | |
| ta-CommonDriftVariant-r17 | INTEGER(0.. 28949) |
| OPTIONAL -- Need R | |
| } | |

NTN-Config field descriptions
EphemerisInfo
This field provides satellite ephemeris either in format of position and velocity state vector or in format
of orbital parameters. this field is excluded when determining changes in system information, i.e.
changes of XXX should neither result in system information change notifications nor in a modification
of valueTag in SIB1.
epochTime
Indicate the epoch time for assistance infomration (i.e. Serving satellite ephemeris in IE ephemerisInfo
and Common TA parameter). When explicit provided through SIB, or through dedicated signaling,
EpochTime is the starting time of a DL sub-frame, indicated by a SFN and a sub-frame number
signaled together with the assistance information. The reference point for epoch time of the serving
satellite ephemeris and Common TA parameters is the uplink time synchronization reference point. If
this field is absent, the epoch time is the end of SI window where this SIB19 is scheduled. This field
is mandatory present when provided in dedicated configuration. If this field is absent in ntn-Config
provided via NTN-NeighCellConfig the UE uses epoch time from the serving satellite ephemeris. In
case of handover, this field is based on the timing of the target cell, i.e. the SFN and sub-frame number
indicated in this field refers to the SFN and sub-frame of the target cell. This field is excluded when
determining changes in system information, i.e. changes of epochTime should neither result in system
information change notification nor in a modification of valueTag in SIB1.
cellSpecificKoffset
The CellSpecific_K_offset is a scheduling offset used for the timing relationships that need to be
modified for NTN [see TS 38.2xy]. The unit of K_offset is number of slots for a given subcarrier
spacing of 15 kHz. If the field is absent UE assumes value 0.
kmac
K-mac is a scheduling offset provided by network if downlink and uplink frame timing are not aligned
at gNB. It is needed for UE action and assumption on downlink configuration indicated by a MAC-CE
command in PDSCH [see TS.38.2xy]. If the field is absent UE assumes value 0.
For the reference subcarrier spacing value of the unit of K_mac in FR1, a value of 15 kHz is used. The
unit of K_mac is number of slots for a given subcarrier spacing.
ntn-PolarizationDL
If present, this parameter indicates polarization information for Downlink transmission on service link:
including Right hand, Left hand circular polarizations (RHCP, LHCP) and Linear polarization.
ntn-PolarizationUL
If present, this parameter indicates Polarization information for Uplink service link.
If not present and ntnPolarizationDL is present, UE assumes a same polarization for UL and DL.
ntn-UISyncValidityDuration
A validity duration configured by the network for uplink synchronization assistance information (i.e.
Serving satellite ephemeris and common TA parameters) which indicates the maximum time during
which the UE can apply assistance information without having acquired new assistance information.
The unit of ntn-UISyncValidityDuration is second. This parameter applies to both connected and idle
mode UEs. This field is excluded when determining changes in system information, i.e. changed of
ntn-UISyncValidityDuration should neither result in system information change notification nor in a
modification of valueTag in SIB1. ntn-UISyncValidityDuration is only updated when at least one of
epochTime, ta-Info, ephemerisInfo is updated.
ta-Common
TACommon is a network-controlled common timing advanced value and it may include any timing
offset considered necessary by the network. TACommon with value of 0 is supported. The granularity
of TACommon is 4.072 × 10\hat{ }(−3) μs.
Values are given in unit of corresponding granularity. This field is excluded when determining changes
in system information. i.e. changes of ta-Common should neither result in sytem information change
notifications nor in a modification of valueTag in SIB1.
ta-CommonDrift
Indicate drift rate of the common TA. The granularity of TACommonDrift is 0.2 × 10\hat{ }(−3) μs/s
Values are given in unit of corresponding granularity. This field is excluded when determining changes
in system information, i.e. changes of ta-CommonDrift should neither result in system information
change notifications nor in a modification of valueTag in SIB1.
ta-CommonDriftVariant
Indicate drift rate variation of the common TA. The granularity of TACommonDriftVariation is
0.2 × 10\hat{ }(−4) μs/s\hat{ }2. Values are given in unit of corresponding granularity. The field is excluded
when determining changes in system information, i.e. changes of ta-CommonDriftVariant should
neither result in system information change notifications nor in a modification of valueTag in SIB1._
ta-Report
When this field is included in SIB19, it indicates TA reporting is enabled during Random Access due to
RRC connection establishment, RRC connection reestablishment and RC connection resume. When this
field is included in ServingCellConfigCommon within dedicated signalling, it indicates TA reporting is
enabled during Random Access due to reconfiguration with sync (see TS 38.321 [3], clause x.x.x).

### ************************************** Next Quotation **************************************

ServingCellConfigCommon

The IE ServingCellConfigCommon is used to configure cell specific parameters of a UE's serving cell. The IE contains parameters which a UE would typically acquire from SSB, MIB or SIBs when accessing the cell from IDLE. With this IE, the network provides this information in dedicated signalling when configuring a UE with a SCells or with an additional cell group (SCG). It also provides it for SpCells (MCG and SCG) upon reconfiguration with sync.

ServingCellConfigCommon information element

| | |
|---|---|
| ServingCellConfigCommon ::= | SEQUENCE { |

| | | |
|---|---|---|
| physCellId | PhysCellId | |
| OPTIONAL, -- Cond HCAndServCellAdd, | | |
| downlinkConfigCommon | DownlinkConfigCommon | |
| OPTIONAL, -- Cond HCAndServCellAdd | | |
| uplinkConfigCommon | UplinkConfigCommon | |
| OPTIONAL, -- Need M | | |
| supplementaryUplinkConfig | UplinkConfigCommon | |
| OPTIONAL, -- Need S | | |
| [...] | | |
| ntn-Config-r17 | NTN-Config-r17 | OPTIONAL -- |
| Need R | | |
| } | | |

### ************************************** Quotation End **************************************

The current endorsed NR MAC CR for NTN is specified in R2-2206503 ([4] R2-2206503, “Corrections to Release-17 NR Non-Terrestrial Networks (NTN)”) as provided below:

************************************** Quotation s tart [4] **********************************

### 5.2a Maintenance of UL Synchronization

The MAC entity shall:
1> if an indication of Serving Cell uplink synchronization has been received from upper layers (see clause 5.2.2.X of TS 38.331 [5]):
   2> allow uplink transmission on the corresponding Serving Cell.
1> if an indication of Serving Cell uplink synchronization loss is received from upper layers:
   2> flush all HARQ buffers;
   2> not perform any uplink transmission on the corresponding Serving Cell.

### ************************************** Quotation End **************************************

Non-terrestrial Network (NTN) is defined as a Next-Generation Radio Access Network (NG-RAN) consisting of gNBs, which provide non-terrestrial access to User Equipment (UE) by means of an NTN payload embarked on an airborne or space-borne NTN vehicle and an NTN Gateway (e.g., [1] RP-201256, “Solutions for NR to support non-terrestrial networks (NTN)”). The UE may link to, camp on and/or connect to the NTN network that involves airborne/spaceborne for transmission. The NTN may comprise various platforms, including low earth orbit (LEO) satellite, medium earth orbit (MEO) satellite, highly elliptical orbit (HEO) satellite, geostationary earth orbit (GEO) satellite, geostationary synchronous Orbit (GSO) satellite, non-geostationary synchronous orbit (NGSO) satellite, and/or high altitude platform station (HAPS). A LEO satellite could have earth-fixed beam (e.g., the beam is temporarily fixed on a location during a time period) or earth-moving beam (e.g., the beam is continuously moving along with the satellite). A LEO satellite could serve/provide earth moving cells (e.g., with earth-fixed beam) and/or (quasi-)earth fixed cells (e.g., with earth-moving beam). The NTN could offer a wide-area coverage and provide Network (NW) access in the scenario when Terrestrial Networks (TN) is unfeasible (e.g., desert, polar area, and/or on an airplane). More details regarding different NTN platforms could be found in TR 38.821 ([2] 3GPP TR 38.821 V16.0.0, “Solutions for NR to support non-terrestrial networks (NTN)”).

The NW would provide parameters needed for the UE to access an NTN cell. According to current NTN Radio Resource Control (RRC) Change Request (CR) ([3] R2-2206502, “Correction for NR NTN WI”), the NW could provide NTN configuration (e.g., NTN-Config) to the UE via system information (e.g., an NTN-specific system information, SIB19) or an RRC Reconfiguration message (e.g., RRCReconfiguration). The NW could provide NTN configuration (e.g., NTN-Config) for serving cell and neighbor cell(s) (e.g., via SIB19) and/or for target cell (e.g., via RRCReconfiguration) to the UE. The NTN configuration (e.g., NTN-Config) may be and/or comprise (satellite) assistance information. The NTN configuration (e.g., NTN-Config) may be or comprise (at least) epoch time (e.g., epochTime), validity duration (e.g., ntn-UlSyncValidityDuration), satellite ephemeris information (e.g., ephemerisinfo) and/or parameters for (common) Timing Advance (TA) (e.g., ta-Info, cellSpecificKoffset, kmac). The NTN configuration (e.g., NTN-Config) may be used by the UE in RRC connected mode, RRC idle mode, and/or RRC inactive mode.

The NTN configuration (e.g., NTN-Config) could be included in system information, which is SIB19 (e.g., System Information Block 19). SIB19 is an NTN-specific system information. SIB19 contains satellite assistance information. The NTN-specific system information and/or SIB19 could be broadcast to the UEs in an NTN cell. The NTN-specific system information and/or SIB19 (of an NTN cell) could be received/acquired/used by multiple UEs in the same NTN cell. The NTN configuration (e.g., NTN-Config) for the serving cell and/or neighbor cell(s) would be included in SIB19. The UE could use the NTN configuration (e.g., NTN-Config) to access the serving cell and/or perform measurement on one or more neighbor cell. Upon receiving SIB19, the UE would (re)start a validity timer (e.g., Txxx in [3] R2-2206502, “Correction for NR NTN WI”) with the validity duration (e.g., ntn-UlSyncValidityDuration) from the subframe indicated by the epoch time (e.g., epochTime). The UE would apply the validity duration (e.g., ntn-UlSyncValidityDuration) as the length of the validity timer. The validity duration (e.g., ntn-UlSyncValidityDuration) may indicate the maximum time during which the UE can apply the assistance information without having acquired new assistance information. Upon the validity timer expiry, the UE would acquire SIB19. The UE would apply the satellite ephemeris information (e.g., ephemerisInfo) and/or parameters for (common) TA (e.g., ta-Info) to perform TA pre-compensation for the serving cell. The UE would apply the parameters for (common) TA (e.g., ta-Info, cellSpecificKoffset, kmac) to perform Uplink (UL) and/or Downlink (DL) transmission. The UE would apply the satellite ephemeris information (e.g., ephemerisInfo) and/or parameters for (common) TA (e.g., ta-Info) to perform intra-frequency, cell reselection and/or Synchronization Signal Block (SSB)-based Radio Resource Management (RRM) Measurement Timing Configuration (SMTC) adjustment for the neighbor cell(s).

The NTN configuration (e.g., NTN-Config) could be included in a serving cell configuration (e.g., ServingCellConfigCommon). The serving cell configuration (e.g., ServingCellConfigCommon) of the special cell (e.g., Primary Cell (PCell)) of the UE could be included in ReconfigurationWithSync, which is included in special cell configuration (e.g., SpCellConfig) of cell group configuration (e.g., CellGroupConfig). And the cell group configuration (e.g., CellGroupConfig) of Master Cell Group (MCG) (e.g., masterCellGroup) could be included in an RRC reconfiguration message (e.g., RRCReconfiguration). The RRC reconfiguration message (e.g., RRCReconfiguration) including ReconfigurationWithSync for MCG is used to handover a UE from a source cell to a target cell. The NTN configuration (e.g., NTN-Config) for a target cell would be included in an RRC reconfiguration message (e.g., RRCReconfiguration including ReconfigurationWithSync). The NW provides NTN configuration for target cell in a handover command (e.g., via RRCReconfiguration).

If the NW would like to handover a UE from a source cell to a target cell, the NW could transmit a handover command/RRC reconfiguration message (e.g., RRCReconfiguration including ReconfigurationWithsync) to the UE indicating the target cell and providing the configuration (e.g., NTN configuration) of the target cell. In response to receiving the handover command/RRC reconfiguration message (e.g., RRCReconfiguration), the UE would access the target cell and transmit an RRC response message (e.g., RRCReconfigurationComplete) to the NW. The UE could use the NTN configuration (e.g., NTN-Config) included in the RRC reconfiguration message (e.g., RRCReconfiguration) to access the target cell (e.g., perform TA pre-compensation for the target cell, perform UL synchronization to the target cell).

In NTN, the cell size is larger than TN and the earth-moving cell would keep moving on the ground. As a result, a large number of UEs would need to perform handover in an NTN cell. The frequent handover may result in signaling overhead and impact power consumption. It is beneficial that some cell-specific information (e.g., NTN configuration) can be reduced in the dedicated signaling (e.g., handover command, RRCReconfiguration) for handover. Then the UE should know how to acquire the NTN configuration which is absent or omitted in a handover command (e.g., RRCReconfiguration), e.g., to access the target cell.

According to the current NR RRC specification, TS 38.331 ([5] 3GPP TS 38.331 V17.0.0, “NR, Radio Resource Control (RRC) protocol specification”), the NTN configuration (NTN-Config) is optional in a handover command (e.g., RRCReconfiguration including ReconfigurationWithsync). When the NW indicates the UE to handover to a target cell, it is possible that the network would not provide some information (or parameters) in the NTN configuration (e.g., NTN-Config) in the handover command/RRC reconfiguration message (e.g., RRCReconfiguration). For the case that the target cell is not an NTN cell (e.g., a TN cell), the NTN configuration is not needed to be included. For the case that the target cell is an NTN cell, the NTN configuration may be required for the UE to access the target cell. However, it may not be necessary to include the NTN configuration in the handover commend (to a target NTN cell) if the UE could derive the NTN configuration other than from the handover command, which could reduce the signaling overhead.

For example, since the UE would obtain NTN configuration (e.g., NTN-Config) in SIB19, some information (or parameters) in the NTN configuration (e.g., NTN-Config) could be reused for the target cell. The NW may provide epoch time (e.g., epochTime) in the RRC reconfiguration message (e.g., RRCReconfiguration) for the target cell. The NW may not provide validity duration (e.g., ntn-UlSyncValidityDuration), satellite ephemeris information (e.g., ephemerisinfo), and/or parameters for (common) TA (e.g., ta-Info) in the RRC reconfiguration message (e.g., RRCReconfiguration). However, SIB19 would comprise an NTN configuration (e.g., NTN-Config) for serving cell and multiple NTN configurations (e.g., NTN-Config) for each neighbor cell. If some information (or parameters) in the NTN configuration (e.g., NTN-Config) are not provided in an RRC reconfiguration message (e.g., RRCReconfiguration), the UE does not know which configuration from SIB19 could be reused. The UE may need to know which validity duration (e.g., ntn-UlSyncValidityDuration), satellite ephemeris information (e.g., ephemerisInfo), and/or parameters for (common) TA (e.g., ta-Info) to use for the target cell.

To solve the issue, for cell change (e.g., handover) from a serving cell (or source cell) to a target cell, the UE could (re)use (or apply) (one or more) first information of a serving cell (or source cell) for a target cell, e.g., based on at least a condition. Alternatively and/or additionally, the UE could (re)use (or apply) (one or more) first information of a neighbor cell (e.g., neighbor cell of the serving cell or the source cell) for a target cell, e.g., based on at least a condition. Alternatively and/or additionally, the UE could (re)use (or apply) (one or more) first information (e.g., of serving/source cell, of a neighbor cell) received in a system information of the serving cell for the target cell, e.g., based on at least a condition. Alternatively and/or additionally, the UE may determine to (re)use (or apply) (one or more) first information of a cell (e.g., serving cell/source cell, a neighbor cell of the serving cell/source cell) for the target cell, e.g., based on at least a condition. Alternatively and/or additionally, the UE may determine to (re)use (or apply) (one or more) first information received form/in a system information of the serving cell (or source cell) for the target cell, e.g., based on at least a condition.

The first information may be (or include) an information included in an NTN configuration (e.g., NTN-Config). The first information of serving cell (or the source cell) may be received in a system information (e.g., SIB19), e.g., of the serving cell (or the source cell), of the target cell. The first information of neighbor cell(s) (e.g., neighbor cell(s) of the serving cell/source cell) may be received in a system information (e.g., SIB19), e.g., system information of the serving cell (or the source cell). The first information of serving cell (or the source cell) may be broadcast by the NW. The first information of neighbor cell(s) (e.g., neighbor cell(s) of the serving cell/source cell) may be broadcast by NW. The first information of serving cell (or the source cell) may be used by the UE for the source cell (or the serving cell). The first information of serving cell (or the source cell) may be used by the UE in the source cell (or the serving cell), e.g., to access the source cell, to perform TA pre-compensation of the source cell (or the serving cell). The first information of neighbor cell(s) (e.g., neighbor cell(s) of the serving cell/source cell) may be used by the UE in the source cell (or the serving cell), e.g., to perform measurement and/or SMTC adjustment for a neighbor cell of the source cell (or the serving cell).

In the following, the serving cell may be the source cell. The source cell may be the serving cell. The neighbor cell may be the neighbor cell of the serving cell (or the source cell). SIB19 may be replaced by system information.

Throughout the disclosure herein, the following may be interchangeable: handover command, RRC reconfiguration message, RRCReconfiguration, RRCReconfiguration including ReconfigurationWithSync, RRCReconfiguration for PCell change.

The UE may receive a system information (e.g., of source cell). The system information (e.g., of source cell) may provide or comprise an NTN configuration of the serving cell. The system information (e.g., of source cell) may provide or comprise NTN configuration(s) of neighbor cell(s). Each neighbor cell indicated in the system information (e.g., of source cell) may be configured with an NTN configuration and/or a PCI. The UE may receive a handover command indicating a target cell and not providing an NTN configuration of the target cell. The UE may use NTN configuration in the system information (e.g., of source cell) for the target cell. The NTN configuration in the system information may be for a neighbor cell. The NTN configuration in the system information may be for the source cell. The UE may use the NTN configuration of the serving cell in the system information (e.g., of source cell) for the target cell. The UE may use the NTN configuration of a neighbor cell in the system information (e.g., of source cell) for the target cell.

The first information of the target cell may not be received in an RRC reconfiguration message (e.g., RRCReconfiguration). The first information of the target cell may not be provided or may be absent or omitted in an RRC reconfiguration message (e.g., RRCReconfiguration). The first information may be (or include) at least one of the below:
validity duration (e.g., ntn-UlSyncValidityDuration);
satellite ephemeris information (e.g., ephemerisinfo); and/or
parameters for (common) TA (e.g., ta-Info).

The NW may provide one or more of the first information without the others. The NW may provide or not provide both of two of the first information. The NW may provide or not provide all of the first information. The NW may provide satellite ephemeris information (e.g., ephemerisInfo) without parameters for (common) TA (e.g., ta-Info) in an NTN configuration (e.g., NTN-Config) (e.g., for target cell). The NW may provide both satellite ephemeris information (e.g., ephemerisInfo) and parameters for (common) TA (e.g., ta-Info) in an NTN configuration (e.g., NTN-Config) (e.g., for target cell). The NW may not provide both satellite ephemeris information (e.g., ephemerisInfo) and parameters for (common) TA (e.g., ta-Info) in an NTN configuration (e.g., NTN-Config) (e.g., for target cell).

The NW may configure (or provide) an NTN configuration (e.g., NTN-Config) for the serving cell in a system information (e.g., SIB19) of the source cell. The NW may configure an NTN configuration (e.g., NTN-Config) for each (indicated) neighbor cell in a system information (e.g., SIB19) of the source cell. The NW may configure a neighbor cell list (e.g., ntn-NeighCellConfigList) in a system information (e.g., SIB19) of the source cell. The neighbor cell list (e.g., ntn-NeighCellConfigList) may comprise (up to four) neighbor cell(s) with Physical Cell Identity(s) (PCI(s)) and NTN configuration(s) (e.g., NTN-Config). Each PCI indicates a neighbor cell associated with an NTN configuration (e.g., NTN-Config). The NW may provide a first information for serving cell (e.g., in SIB19). The NW may provide a first information for each neighbor cell (e.g., in SIB19). The NW may not provide the first information for the target cell (e.g., in RRCReconfiguration). The NW may provide the first information (e.g., in system information) before a handover procedure. The NW may not provide the first information during a handover procedure.

The UE may apply a first information of serving cell (e.g., the source cell) as the first information for target cell, e.g., if a condition is fulfilled. The UE may apply a first information of one of the neighbor cell(s) (indicated in SIB19) as the first information for target cell, e.g., if a condition is fulfilled. The UE may apply a first information received in a system information (e.g., SIB19) for target cell, e.g., if a condition is fulfilled. The UE may (re)use and/or apply one or more first information of a serving cell or of a neighbor cell (received in a system information (e.g., SIB19)) as first information for the target cell based on one or more conditions. The condition may be at least one of the below.

### Implicit Indication

The condition may be that a first information is not received (or absent) in (an NTN configuration (e.g., NTN-Config) in) an RRC reconfiguration message (e.g., RRCReconfiguration). The UE may receive an RRC reconfiguration message (e.g., RRCReconfiguration) comprising NTN configuration (e.g., NTN-Config) without a first information. The UE may receive an RRC reconfiguration message (e.g., RRCReconfiguration) not comprising a first information. The RRC reconfiguration message (e.g., RRCReconfiguration) may indicate an NTN cell. The RRC reconfiguration message (e.g., RRCReconfiguration) may indicate that (PCI of) the target cell is an NTN cell.

The UE may determine to use or apply a first information (e.g., NTN configuration) in a system information (of source cell) for a target cell based on or in response to receiving a handover command/RRC reconfiguration message (e.g., RRCReconfiguration) not providing first information (e.g., NTN configuration) of the target cell. The first information (e.g., NTN configuration) in the system information (of source cell) may be a first information (e.g., NTN configuration) of the source cell. The first information (e.g., NTN configuration) in the system information (of source cell) may be a first information (e.g., NTN configuration) of a neighbor cell (of the source cell).

### Explicit Indication

The condition may be that an indication is received in a handover command/RRC reconfiguration message (e.g., RRCReconfiguration). The UE may receive a handover command/RRC reconfiguration message (e.g., RRCReconfiguration) comprising an indication of serving cell or one of the neighbor cell(s) (e.g., list in SIB19). The indication may be a Boolean. The indication may indicate the serving cell or the neighbor cell. The indication may be a PCI. The indication may indicate a PCI of the serving cell or one of the neighbor cell(s). The indicating PCI may be different from the PCI of the target cell. The indication may be a number and/or index. The indication may indicate the serving cell or one of the neighbor cell(s) based on the sequence/list of the cells configured in SIB19.

The UE may determine to use or apply a first information (e.g., NTN configuration) in a system information (of source cell) for a target cell based on or in response to receiving a handover command/RRC reconfiguration message (e.g., RRCReconfiguration) indicating a PCI of a neighbor cell. The first information (e.g., NTN configuration) in the system information (of source cell) may be a first information (e.g., NTN configuration) of the neighbor cell (of the source cell).

The UE may determine to use or apply a first information (e.g., NTN configuration) in a system information (of source cell) for a target cell based on or in response to receiving a handover command/RRC reconfiguration message (e.g., RRCReconfiguration) indicating a PCI of the serving cell. The first information (e.g., NTN configuration) in the system information (of source cell) may be a first information (e.g., NTN configuration) of the source cell.

The UE may determine to use or apply a first information (e.g., NTN configuration) in a system information (of source cell) for a target cell based on or in response to receiving a handover command/RRC reconfiguration message (e.g., RRCReconfiguration) indicating a PCI not of a neighbor cell (indicated in the system information). The first information (e.g., NTN configuration) in the system information (of source cell) may be a first information (e.g., NTN configuration) of the source cell.

### Target Cell's PCI

The condition may be that the PCI of the target cell (e.g., indicated in a handover command) is the same as one of the neighbor cell(s) indicated in a system information (e.g., SIB19), e.g., of the source cell. The UE may receive an RRC reconfiguration message (e.g., RRCReconfiguration) comprising (or indicating) the PCI of the target cell. The PCI of the target cell may be (the same as) one of the PCIs of neighbor cell(s) indicated in the neighbor cell list (e.g., ntn-NeighCellConfigList) in a system information (e.g., SIB19), e.g., of the source cell. The (PCI of) target cell may be (the same as) one of the (PCI of) neighbor cells indicated (in ntn-NeighCellConfigList) in a system information (e.g., SIB19), e.g., of the source cell.

The UE may determine to use or apply a first information (e.g., NTN configuration) in a system information (of source cell) for the target cell based on or in response to receiving a handover command/RRC reconfiguration message (e.g., RRCReconfiguration) indicating a PCI of the target cell, which is the same as the PCI of a neighbor cell indicated in the system information. The first information (e.g., NTN configuration) in the system information (of source cell) may be a first information (e.g., NTN configuration) of the neighbor cell (of the source cell).

The UE may apply a first information for a target cell upon/after a handover procedure is triggered and/or a handover procedure is completed. The UE may apply a first information for the target cell during a handover procedure. The UE may apply/use the first information in SIB19 (e.g., of the source cell) and/or the first information in RRC reconfiguration message (e.g., RRCReconfiguration) for the target cell. The UE may derive TA for the target cell based on its location and one or more of the first information. The UE may apply one or more of the first information to perform TA pre-compensation for the target cell. The UE may apply one or more of the first information to maintain/perform UL synchronization of the target cell.

Throughout the disclosure herein, the handover procedure may correspond to, may be supplemented with, and/or may be replaced by RRC reconfiguration procedure and/or procedure of reconfiguration with sync. Throughout the disclosure herein, the “handover” may correspond to, may be supplemented with, and/or may be replaced by “reconfiguration with sync”. The NW would handover a UE from a source cell to a target cell. The source cell and the target cell may be different cells. The source cell and the target cell may be of the same satellite. The source cell and the target cell may be of different satellites. The source cell and the target cell may be of the same network type. The source cell and the target cell may be of different network types. The source cell and the target cell may be linked to the same gateway and/or gNB. The source cell and the target cell may be linked to different gateways and/or gNBs. The handover may be serving link handover and/or feeder link handover.

The handover procedure may be Random Access (RA)-based and/or Random Access Channel (RACH)-less. The handover procedure may be a procedure that the UE changes the PCell from a source cell to a target cell. The UE may or may not trigger an RA procedure in response to receiving an RRC reconfiguration message (e.g., RRCReconfigurtaion). The UE may or may not trigger an RA procedure for a handover procedure. For an RA-based handover procedure, the UE may trigger an RA procedure (e.g., a 2-step RA, 4-step RA, contention-based RA and/or contention free RA procedure) and transmit an RRC message (e.g., RRCReconfigurationComplete) in MSGB, Msg4 and/or subsequent UL transmission after MSGB/Msg4. For a RACH-less handover procedure, the UE may not trigger an RA procedure and the UE may transmit an RRC message (e.g., RRCReconfigurationComplete) in a configured grant (e.g., received in RRCReconfigurtaion) and/or a dynamic grant (e.g., received on the PDCCH of target cell).

A handover procedure may be triggered upon the UE receiving an RRC reconfiguration message (e.g., RRCReconfigurtaion) and/or upon the UE triggering an RA procedure (for handover). A handover procedure may be completed upon the UE transmitting an RRC message (e.g., RRCReconfigurationComplete) in response to an RRC reconfiguration message (e.g., RRCReconfigurtaion). A handover procedure may be completed upon the UE camping/linking to the target cell.

In one example, the UE may receive a first NTN configuration (e.g., NTN-Config) for the serving cell in SIB19. The first NTN configuration (e.g., NTN-Config) may comprise a first ta-Info and a first ephemerisInfo. The UE may receive an RRC reconfiguration message (e.g., RRCReconfiguration) to trigger a handover (e.g., due to feeder link switch). The UE may receive a second ta-Info in the RRC reconfiguration message (e.g., RRCReconfiguration). The UE may not receive a second ephemerisInfo in the RRC reconfiguration message (e.g., RRCReconfiguration). The UE may use the second ta-Info and the first ephemerisInfo for the target cell. The UE may perform TA pre-compensation for the target cell based on the second ta-Info and the first ephemerisInfo.

In one example, the UE may receive a first NTN configuration (e.g., NTN-Config) for the serving cell and a second NTN configuration (e.g., NTN-Config) for a neighbor cell in SIB19. The first NTN configuration (e.g., NTN-Config) may comprise a first ntn-UlSyncValidityDuration, a first ta-Info, and a first ephemerisInfo. The second NTN configuration (e.g., NTN-Config) may comprise a second ntn-UlSyncValidityDuration, a second ta-Info, and a second ephemerisInfo. The UE may receive an RRC reconfiguration message (e.g., RRCReconfiguration) to trigger a handover. The UE may receive a third ntn-UlSyncValidityDuration in the RRC reconfiguration message (e.g., RRCReconfiguration). The UE may not receive a third ta-Info and a third ephemerisInfo in the RRC reconfiguration message (e.g., RRCReconfiguration). The UE may receive an indication to the neighbor cell in the RRC reconfiguration message (e.g., RRCReconfiguration). The UE may use the third ntn-UlSyncValidityDuration, the second ta-Info, and the second ephemerisInfo for the target cell. The UE may perform TA pre-compensation for the target cell based on the second ta-Info and the second ephemerisInfo. The UE may perform UL synchronization based on the third ntn-UlSyncValidityDuration for the target cell.

In one example, the UE may receive a first NTN configuration (e.g., NTN-Config) for the serving cell, a second NTN configuration (e.g., NTN-Config) for a first neighbor cell, and a third NTN configuration (e.g., NTN-Config) for a second neighbor cell in SIB19. The first NTN configuration (e.g., NTN-Config) may comprise a first ntn-UlSyncValidityDuration, a first ta-Info, and a first ephemerisInfo. The second NTN configuration (e.g., NTN-Config) may comprise a second ntn-UlSyncValidityDuration, a second ta-Info, and a second ephemerisInfo. The third NTN configuration (e.g., NTN-Config) may comprise a third ntn-UlSyncValidityDuration, a third ta-Info, and a third ephemerisInfo. The UE may receive an RRC reconfiguration message (e.g., RRCReconfiguration) to trigger a handover. The UE may not receive a fourth ntn-UlSyncValidityDuration, fourth ta-Info and fourth ephemerisInfo in the RRC reconfiguration message (e.g., RRCReconfiguration). The UE may receive a first PCI for the target cell in the RRC reconfiguration message (e.g., RRCReconfiguration). The first PCI may be the same as the PCI of the second neighbor cell. The UE may use the third ntn-UlSyncValidityDuration, third ta-Info, and third ephemerisInfo for the target cell. The UE may perform TA pre-compensation for the target cell based on the third ta-Info and the third ephemerisInfo. The UE may perform UL synchronization based on the third ntn-UlSyncValidityDuration for the target cell.

In one example, the UE may receive a first NTN configuration (e.g., NTN-Config) in a system information (e.g., SIB19) of the source cell. The first NTN configuration (e.g., NTN-Config) may comprise a first epochtime, a first ntn-UlSyncValidityDuration, a first ta-Info, and a first ephemerisInfo. The first NTN configuration (e.g., NTN-Config) may be an NTN configuration (e.g., NTN-Config) of the source cell. The first NTN configuration (e.g., NTN-Config) may be an NTN configuration (e.g., NTN-Config) of a neighbor cell. The UE may receive an RRC reconfiguration message (e.g., RRCReconfiguration) to trigger a handover. The UE may receive (one or more of) a second epochtime, a second ntn-UlSyncValidityDuration, a second ta-Info, and/or a second ephemerisInfo in the RRC reconfiguration message (e.g., RRCReconfiguration). The UE may not receive (one or more of) the second epochtime, the second ntn-UlSyncValidityDuration, the second ta-Info, and/or the second ephemerisInfo in the RRC reconfiguration message (e.g., RRCReconfiguration). The UE may use the first epochtime, first ntn-UlSyncValidityDuration, first ta-Info, and first ephemerisInfo for the target cell. The UE may use the first epochtime, first ntn-UlSyncValidityDuration, second ta-Info, and first ephemerisInfo for the target cell. The UE may use the first epochtime, second ntn-UlSyncValidityDuration, second ta-Info, and first ephemerisInfo for the target cell. The UE may use the second epochtime, second ntn-UlSyncValidityDuration, second ta-Info, and first ephemerisInfo for the target cell. The UE may use the second epochtime, second ntn-UlSyncValidityDuration, first ta-Info, and second ephemerisInfo for the target cell.

To solve the issue, the NW could (always) provide the first information for a target cell (e.g., in RRCReconfiguration), e.g., for the case that the target cell is an NTN cell, during a handover procedure. The first information (for a target cell) may be mandatory in a handover command (e.g., RRCReconfiguration with reconfigWithSync, RRCReconfiguration for PCell change) if the target cell is an NTN cell. The first information (for a target cell) may be (always) present in a handover command (e.g., RRCReconfiguration with reconfigWithSync, RRCReconfiguration for PCell change), e.g., if the target cell is an NTN cell. The first information (for a target cell) may not be absent in a handover command (e.g., RRCReconfiguration with reconfigWithSync, RRCReconfiguration for PCell change), e.g., if the target cell is an NTN cell. The first information (for a target cell) may not be absent or omitted in a handover command (e.g., RRCReconfiguration with reconfigWithSync, RRCReconfiguration for PCell change), e.g., if the target cell is an NTN cell. The NW may provide the first information during a handover procedure (e.g., for the case that the target cell is an NTN cell). The NW may not omit (any of) the first information in an RRC reconfiguration message (e.g., RRCReconfiguration), e.g., for the case that the target cell is an NTN cell. The UE may (always) receive the first information in an RRC reconfiguration message (e.g., RRCReconfiguration with reconfigWithSync, RRCReconfiguration for PCell change), e.g., for the case that the target cell is an NTN cell. The UE may (always) receive the first information for the target cell (e.g., for the case that the target cell is an NTN cell), e.g., during a handover procedure. The UE may not reuse a first information received in SIB19 of source cell for the target cell. The UE may derive TA for the target cell based on its location and one or more of the first information. UE may apply one or more of the first information to perform TA pre-compensation for the target cell. UE may apply one or more of the first information to maintain/perform UL synchronization of the target cell.

For example, the UE may receive a first NTN configuration (e.g., NTN-Config) for the serving cell, a second NTN configuration (e.g., NTN-Config) for a first neighbor cell, and a third NTN configuration (e.g., NTN-Config) for a second neighbor cell in SIB19. The first NTN configuration (e.g., NTN-Config) may comprise a first ntn-UlSyncValidityDuration, a first ta-Info, and a first ephemerisInfo. The second NTN configuration (e.g., NTN-Config) may comprise a second ntn-UlSyncValidityDuration, a second ta-Info, and a second ephemerisInfo. The third NTN configuration (e.g., NTN-Config) may comprise a third ntn-UlSyncValidityDuration, a third ta-Info, and a third ephemerisInfo. The UE may receive an RRC reconfiguration message (e.g., RRCReconfiguration) to trigger a handover. The UE may receive a fourth ntn-UlSyncValidityDuration, a fourth ta-Info, and a fourth ephemerisInfo in the RRC reconfiguration message (e.g., RRCReconfiguration). The UE may use the fourth ntn-UlSyncValidityDuration, fourth ta-Info, and fourth ephemerisInfo for the target cell. The UE may perform TA pre-compensation for the target cell based on the fourth ta-Info and the fourth ephemerisInfo. The UE may perform UL synchronization based on the fourth ntn-UlSyncValidityDuration for the target cell.

In addition, for common signaling for handover, an NTN configuration (e.g., NTN-config) for the target cell may be redundant since a neighbor cell list (e.g., ntn-NeighCellConfigList-r17) could include the NTN configuration (e.g., NTN-config) for the target cell.

In one example, the UE could reuse an NTN configuration (e.g., NTN-config) in a neighbor cell list (e.g., ntn-NeighCellConfigList-r17) for the target cell. The neighbor cell list (e.g., ntn-NeighCellConfigList-r17) may include the NTN configuration (e.g., NTN-config) for the target cell. The neighbor cell list (e.g., ntn-NeighCellConfigList-r17) may not include the NTN configuration (e.g., NTN-config) for the target cell.

In one example, if a first NTN configuration (e.g., NTN-config) for the target cell is absent (or not provided) in a common signaling for handover, the UE may apply a second NTN configuration (e.g., NTN-config) in a neighbor cell list (e.g., ntn-NeighCellConfigList-r17) for the target cell.

In one example, a common signaling for handover may indicate a pointer (e.g., based on PCI) to a neighbor cell list (e.g., ntn-NeighCellConfigList-r17). The common signaling may not include a PCI of a neighbor cell in the neighbor cell list (e.g., ntn-NeighCellConfigList-r17). The common signaling may not include a (whole) NTN configuration (e.g., NTN-config) for the target cell.

The common signaling may be transmitted to more than one UE (e.g., a group of UEs). The common signaling may be transmitted or broadcast to multiple UEs. The common signaling may be an RRC message, Medium Access Control (MAC) Control Element (CE) or Downlink Control Information (DCI). The common signaling may be an RRC reconfiguration message (e.g., RRCReconfiguration), a handover command, a system information (e.g., SIB19), and/or a paging message. The common signaling may be and/or comprise a common configuration (e.g., ServingCellConfigCommon), e.g., to multiple UEs. The common signaling may be a (group) handover configuration and/or a (group) handover indication. The common signaling may provide resources to (a group of) UEs for handover.

Throughout the disclosure, the handover command and/or RRC reconfiguration message may be applied for handover enhancements such as common handover, group handover, and/or 2-step handover. The handover command and/or RRC reconfiguration message may be dedicated to a UE. The handover command and/or RRC reconfiguration message may be common to multiple UEs.

Throughout the disclosure herein, the (serving/neighbor/target/source) cell may be (referred to) an NTN cell. The handover may be NTN-NTN handover (e.g., from an NTN cell to an NTN cell). The handover may be from a LEO cell to a LEO cell. The handover may be from a GEO cell to a LEO cell. The handover may be from a LEO cell to a GEO cell. The source cell may be the (current) serving cell of the UE. The target cell may be indicated by the NW in handover command/RRC reconfiguration message (e.g., RRCReconfigurtaion). The neighbor cell(s) may be the cell(s) neighbor to the serving cell. The neighbor cell(s) may be the cell(s) neighbor to the source cell. The neighbor cell(s) may be the neighbor cell(s) indicated in SIB19 (of the serving cell).

In one example, the UE may link to and/or camp to a first cell. The UE may receive a system information of the first cell. The system information may comprise an NTN configuration (e.g., NTN-Config) for the first cell. The system information may comprise a neighbor cell list (e.g., ntn-NeighCellConfigList) indicating at least a PCI and an NTN configuration (e.g., NTN-Config) for a second cell. The UE may receive a handover command indicated (PCI of) a third cell. The UE may handover to the third cell from the first cell. The first cell may be a serving cell, e.g., associated to the system information. The first cell may be a source cell, e.g., associated to the handover command. The second cell may be a neighbor cell (of the first cell), e.g., associated to the system information. The third cell may be a target cell, e.g., associated to the handover command.

Throughout the disclosure herein, the SIB19 may be SIB19 for the source cell.

The UE may be in a cell of NTN. The UE may be connected to a cell of NTN. The UE may be connected to a LEO, GEO, MEO, HEO, and/or HAPS.

The UE may be referring to the UE, an RRC entity of the UE, or a MAC entity of the UE.

The UE may be an NR device. The UE may be an NR-light device. The UE may be a reduced capability device. The UE may be a mobile phone. The UE may be a wearable device. The UE may be a sensor. The UE may be a stationary device.

The network may be a network node. The network may be a base station. The network may be an access point. The network may be an eNB. The network may be a gNB. The network may be a gateway.

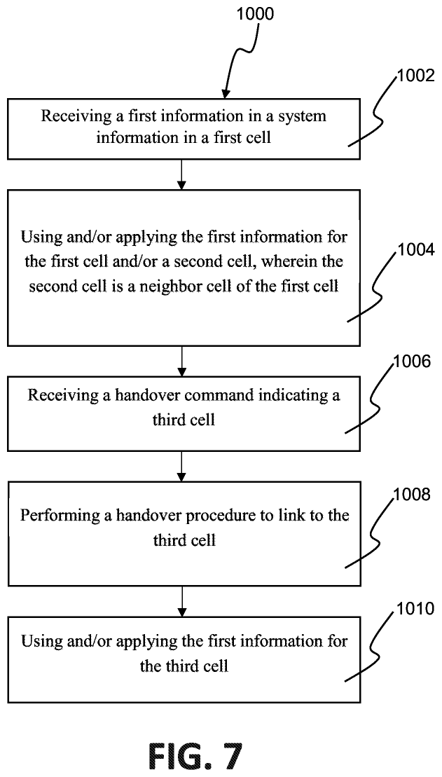

Referring to FIG. 7, with this and other concepts, systems, and methods of the present invention, a method 1000 for a UE in a wireless communication system comprises receiving a first information in a system information in a first cell (step 1002), using and/or applying the first information for the first cell and/or a second cell, wherein the second cell is a neighbor cell of the first cell (step 1004), receiving a handover command indicating a third cell (step 1006), performing a handover procedure to link to the third cell (step 1008), and using and/or applying the first information for the third cell (step 1010).

In various embodiments, the first information is (or includes) at least one of validity duration (e.g., ntn-UlSyncValidityDuration), satellite ephemeris information (e.g., ephemerisInfo), and/or parameters for (common) TA (e.g., ta-Info).

In various embodiments, the first information is included/configured in an NTN configuration (e.g., NTN-Config).

In various embodiments, the second cell is indicated in the system information.

In various embodiments, the first cell and the third cell are different cells.

In various embodiments, the second cell and the third cell are the same cell.

In various embodiments, the second cell and the third cell are different cells.

In various embodiments, the first cell, the second cell, and the third cell are cells of an NTN.

In various embodiments, the UE does not receive another first information in the handover command.

In various embodiments, the UE receives an indication of the first cell or the second cell in the handover command.

In various embodiments, the UE uses the first information to perform TA pre-compensation, UL synchronization, intra-frequency, cell reselection, and/or SMTC adjustments.

Referring back to FIGS. 3 and 4, in one or more embodiments from the perspective of a UE, the device 300 includes a program code 312 stored in memory 310 of the transmitter. The CPU 308 could execute program code 312 to: (i) receive a first information in a system information in a first cell; (ii) use and/or apply the first information for the first cell and/or a second cell, wherein the second cell is a neighbor cell of the first cell; (iii) receive a handover command indicating a third cell; (iv) perform a handover procedure to link to the third cell; and (v) use and/or apply the first information for the third cell. Moreover, the CPU 308 can execute the program code 312 to perform all of the described actions, steps, and methods described above, below, or otherwise herein.

Referring back to FIGS. 3 and 4, in one or more embodiments from the perspective of a NW, the device 300 includes a program code 312 stored in memory 310 of the transmitter. The CPU 308 could execute program code 312 to: (i) transmit to a UE a first information in a system information in a first cell; (ii) at the UE, use and/or apply the first information for the first cell and/or a second cell, wherein the second cell is a neighbor cell of the first cell; (iii) transmit to the UE a handover command indicating a third cell; (iv) at the UE, perform a handover procedure to link to the third cell; and (v) at the UE, use and/or apply the first information for the third cell. Moreover, the CPU 308 can execute the program code 312 to perform all of the described actions, steps, and methods described above, below, or otherwise herein.

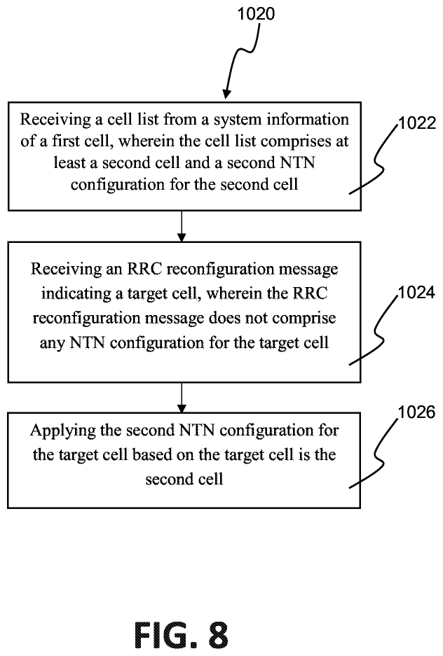

Referring to FIG. 8, with this and other concepts, systems, and methods of the present invention, a method 1020 for a UE in a wireless communication system comprises receiving a cell list from a system information of a first cell, wherein the cell list comprises at least a second cell and a second NTN configuration for the second cell (step 1022), receiving an RRC reconfiguration message indicating a target cell, wherein the RRC reconfiguration message does not comprise any NTN configuration for the target cell (step 1024), and applying the second NTN configuration for the target cell based on the target cell is the second cell (step 1026).

In various embodiments, the method further comprises receiving at least a first NTN configuration for a first cell and/or a second NTN configuration for a second cell with a first PCI via a system information of the first cell, receiving an RRC reconfiguration message indicating a target cell with a second PCI, and performing at least one of: (1) applying the first NTN configuration for the target cell if the RRC reconfiguration message does not comprise an NTN configuration for the target cell, or (2) applying the second NTN configuration for the target cell if the first PCI is the same as the second PCI and/or the RRC reconfiguration message does not comprise the NTN configuration for the target cell.

In various embodiments, the method further comprises applying the first NTN configuration for the target cell, e.g., if the RRC reconfiguration message does not comprise an NTN configuration for the target cell, if the first PCI is different from the second PCI.

In various embodiments, the second cell and the target cell are configured with the same PCI.

In various embodiments, the method further comprises performing UL synchronization and/or TA pre-compensation for the target cell using the first NTN configuration or the second NTN configuration.

In various embodiments, the method further comprises performing a handover to the target cell in response to receiving the RRC reconfiguration message.

In various embodiments, the method further comprises applying the first NTN configuration or the second NTN configuration for the target cell in response to performing a handover to the target cell.

In various embodiments, the NTN configuration comprises at least one of validity duration (e.g., ntn-UlSyncValidityDuration), ephemeris data (e.g., EphemerisInfo), and/or common TA parameters (e.g., Ta-Info).

In various embodiments, the system information is a SIB specific to NTN and/or the system information is broadcast to multiple UEs in the first cell.

In various embodiments, the second NTN configuration is included in a neighbor cell list.

In various embodiments, the first cell and the target cell are different cells.

In various embodiments, the first cell and the second cell are different cells.

In various embodiments, the second cell is a cell neighboring to the first cell, indicated in the system information.

In various embodiments, the target cell and the second cell are the same cell.

In various embodiments, the target cell and the second cell are different cells.

In various embodiments, the target cell is a cell indicating in a handover command and/or RRC reconfiguration message.

In various embodiments, the second cell is indicated with and/or associated with the first PCI.

In various embodiments, the target cell is indicated with and/or associated with the second PCI.

In various embodiments, the method further comprises applying the first NTN configuration for the first cell before receiving the RRC reconfiguration message.

Referring back to FIGS. 3 and 4, in one or more embodiments from the perspective of a UE, the device 300 includes a program code 312 stored in memory 310 of the transmitter. The CPU 308 could execute program code 312 to: (i) receive a cell list from a system information of a first cell, wherein the cell list comprises at least a second cell and a second NTN configuration for the second cell; (ii) receive an RRC reconfiguration message indicating a target cell, wherein the RRC reconfiguration message does not comprise any NTN configuration for the target cell; and (iii) apply the second NTN configuration for the target cell based on the target cell is the second cell. Moreover, the CPU 308 can execute the program code 312 to perform all of the described actions, steps, and methods described above, below, or otherwise herein.

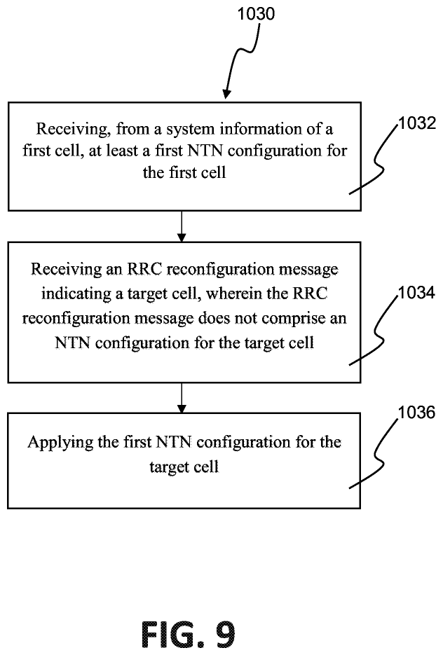

Referring to FIG. 9, with this and other concepts, systems, and methods of the present invention, a method 1030 for a UE in a wireless communication system comprises receiving, from a system information of a first cell, at least a first NTN configuration for the first cell (step 1032), receiving an RRC reconfiguration message indicating a target cell, wherein the RRC reconfiguration message does not comprise an NTN configuration for the target cell (step 1034), and applying the first NTN configuration for the target cell (step 1036).

In various embodiments, the method further comprises performing UL synchronization and/or TA pre-compensation for the target cell using the first NTN configuration.

In various embodiments, the method further comprises applying the first NTN configuration for the target cell in response to performing a handover to the target cell.

In various embodiments, the method further comprises applying the first NTN configuration for the target cell in response to receiving the RRC reconfiguration message.

In various embodiments, the first cell and the target cell are different cells.

In various embodiments, the method further comprises applying the first NTN configuration for the first cell before receiving the RRC reconfiguration message.

In various embodiments, the first cell is a serving cell of the UE.

Referring back to FIGS. 3 and 4, in one or more embodiments from the perspective of a UE, the device 300 includes a program code 312 stored in memory 310 of the transmitter. The CPU 308 could execute program code 312 to: (i) receive, from a system information of a first cell, at least a first NTN configuration for the first cell; (ii) receive an RRC reconfiguration message indicating a target cell, wherein the RRC reconfiguration message does not comprise an NTN configuration for the target cell; and (iii) apply the first NTN configuration for the target cell. Moreover, the CPU 308 can execute the program code 312 to perform all of the described actions, steps, and methods described above, below, or otherwise herein.

Any combination of the above concepts or teachings can be jointly combined or formed to a new embodiment. The disclosed details and embodiments can be used to solve at least (but not limited to) the issues mentioned above and herein.

It is noted that any of the methods, alternatives, steps, examples, and embodiments proposed herein may be applied independently, individually, and/or with multiple methods, alternatives, steps, examples, and embodiments combined together.

Various aspects of the disclosure have been described above. It should be apparent that the teachings herein may be embodied in a wide variety of forms and that any specific structure, function, or both being disclosed herein is merely representative. Based on the teachings herein one skilled in the art should appreciate that an aspect disclosed herein may be implemented independently of any other aspects and that two or more of these aspects may be combined in various ways. For example, an apparatus may be implemented or a method may be practiced using any number of the aspects set forth herein. In addition, such an apparatus may be implemented or such a method may be practiced using other structure, functionality, or structure and functionality in addition to or other than one or more of the aspects set forth herein. As an example of some of the above concepts, in some aspects, concurrent channels may be established based on pulse repetition frequencies. In some aspects, concurrent channels may be established based on pulse position or offsets. In some aspects, concurrent channels may be established based on time hopping sequences. In some aspects, concurrent channels may be established based on pulse repetition frequencies, pulse positions or offsets, and time hopping sequences.

Those of ordinary skill in the art would understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Those of ordinary skill in the art would further appreciate that the various illustrative logical blocks, modules, processors, means, circuits, and algorithm steps described in connection with the aspects disclosed herein may be implemented as electronic hardware (e.g., a digital implementation, an analog implementation, or a combination of the two, which may be designed using source coding or some other technique), various forms of program or design code incorporating instructions (which may be referred to herein, for convenience, as “software” or a “software module”), or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

In addition, the various illustrative logical blocks, modules, and circuits described in connection with the aspects disclosed herein may be implemented within or performed by an integrated circuit (“IC”), an access terminal, or an access point. The IC may comprise a general purpose processor, a digital signal processor (DSP), an application specific integrated circuit (ASIC), a field programmable gate array (FPGA) or other programmable logic device, discrete gate or transistor logic, discrete hardware components, electrical components, optical components, mechanical components, or any combination thereof designed to perform the functions described herein, and may execute codes or instructions that reside within the IC, outside of the IC, or both. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

It is understood that any specific order or hierarchy of steps in any disclosed process is an example of a sample approach. Based upon design preferences, it is understood that the specific order or hierarchy of steps in the processes may be rearranged while remaining within the scope of the present disclosure. The accompanying method claims present elements of the various steps in a sample order, and are not meant to be limited to the specific order or hierarchy presented.

The steps of a method or algorithm described in connection with the aspects disclosed herein may be embodied directly in hardware, in a software module executed by a processor, or in a combination of the two. A software module (e.g., including executable instructions and related data) and other data may reside in a data memory such as RAM memory, flash memory, ROM memory, EPROM memory, EEPROM memory, registers, a hard disk, a removable disk, a CD-ROM, or any other form of computer-readable storage medium known in the art. A sample storage medium may be coupled to a machine such as, for example, a computer/processor (which may be referred to herein, for convenience, as a “processor”) such the processor can read information (e.g., code) from and write information to the storage medium. A sample storage medium may be integral to the processor. The processor and the storage medium may reside in an ASIC. The ASIC may reside in user equipment. In the alternative, the processor and the storage medium may reside as discrete components in user equipment.

Moreover, in some aspects, any suitable computer-program product may comprise a computer-readable medium comprising codes relating to one or more of the aspects of the disclosure. In some aspects, a computer program product may comprise packaging materials.

While the invention has been described in connection with various aspects and examples, it will be understood that the invention is capable of further modifications. This application is intended to cover any variations, uses or adaptation of the invention following, in general, the principles of the invention, and including such departures from the present disclosure as come within the known and customary practice within the art to which the invention pertains.

What is claimed is:

1. A method for a User Equipment (UE), comprising:
receiving a cell list from a system information of a first cell, wherein the cell list comprises at least a second cell and a second Non-Terrestrial Network (NTN) configuration for the second cell;
receiving a Radio Resource Control (RRC) reconfiguration message indicating a target cell, wherein the RRC reconfiguration message does not comprise any NTN configuration for the target cell; and
applying the second NTN configuration for the target cell based on the target cell is the second cell.

2. The method of claim 1, wherein the second cell and the target cell are configured with the same Physical Cell Identity (PCI).

3. The method of claim 1, further comprising performing Uplink (UL) synchronization and/or Timing Advance (TA) pre-compensation for the target cell using the second NTN configuration.

4. The method of claim 1, further comprising performing a handover to the target cell in response to receiving the RRC reconfiguration message.

5. The method of claim 4, further comprising applying the second NTN configuration for the target cell in response to performing the handover to the target cell.

6. The method of claim 1, wherein the NTN configuration comprises at least one of validity duration, ephemeris data, and/or common TA parameters.

7. The method of claim 1, wherein the first cell and the target cell are different cells, wherein the first cell and the second cell are different cells, and/or wherein the second cell is a cell neighboring to the first cell, indicated in the system information.

8. A User Equipment (UE), comprising:
a memory; and
a processor operatively coupled to the memory, wherein the processor is configured to execute program code to:
receive a cell list from a system information of the first cell, wherein the cell list comprises at least a second cell and a second Non-Terrestrial Network (NTN) configuration for the second cell;
receive a Radio Resource Control (RRC) reconfiguration message indicating a target cell, wherein the RRC reconfiguration message does not comprise any NTN configuration for the target cell; and
apply the second NTN configuration for the target cell based on the target cell is the second cell.

9. The UE of claim 8, wherein the second cell and the target cell are configured with the same Physical Cell Identity (PCI).

10. The UE of claim 8, wherein the processor is further configured to execute program code to perform Uplink (UL) synchronization and/or Timing Advance (TA) pre-compensation for the target cell using the second NTN configuration.

11. The UE of claim 8, wherein the processor is further configured to execute program code to perform a handover to the target cell in response to receiving the RRC reconfiguration message.

12. The UE of claim 11, wherein the processor is further configured to execute program code to apply the second NTN configuration for the target cell in response to performing the handover to the target cell.

13. The UE of claim 8, wherein the NTN configuration comprises at least one of validity duration, ephemeris data, and/or common TA parameters.

14. The UE of claim 8, wherein the first cell and the target cell are different cells, wherein the first cell and the second cell are different cells, and/or wherein the second cell is a cell neighboring to the first cell, indicated in the system information.

15. A method for a User Equipment (UE), comprising:
receiving, from a system information of a first cell, at least a first Non-Terrestrial Network (NTN) configuration for the first cell;
receiving a Radio Resource Control (RRC) reconfiguration message indicating a target cell, wherein the RRC reconfiguration message does not comprise an NTN configuration for the target cell; and
applying the first NTN configuration for the target cell.

16. The method of claim 15, further comprising performing Uplink (UL) synchronization and/or Timing Advance (TA) pre-compensation for the target cell using the first NTN configuration.

17. The method of claim 15, further comprising applying the first NTN configuration for the target cell in response to receiving the RRC reconfiguration message and/or performing a handover to the target cell.

18. The method of claim 15, wherein the first cell and the target cell are different cells.

19. The method of claim 15, further comprising applying the first NTN configuration for the first cell before receiving the RRC reconfiguration message.

20. The method of claim 15, wherein the first cell is a serving cell of the UE.
